(19) United States
(12) Patent Application Publication
(10) Pub. No.: US 2005/0234882 A1
(43) Pub. Date: Oct. 20, 2005

(54) Data structure for a hardware database management system

(75) Inventors: Victor A. Bennett, Rockwall, TX (US); Frederick R. Petersen, Dallas, TX (US)

Correspondence Address: DLA PIPER RUDNICK GRAY CARY US, LLP, 2000 UNIVERSITY AVENUE, E. PALO ALTO, CA, 94303-2248, US

(73) Assignee: Calpont Corporation, Rockwall, TX (US)

(21) Appl. No.: 10/827,744

(22) Filed: Apr. 20, 2004

(51) Int. Cl. G06F 7/00

(52) U.S. Cl. 707/3

(57) ABSTRACT

A data structure for a hardware database system is described. The data structure is made up of multiple sub-trees interconnected to form a graph structure. Each sub-tree begins at a memory location, or root address. Next the sub-tree includes profile information relevant to the sub-tree, such profile information can include, but is not limited to, information on the type of data being stored, the number of entries in the sub-tree, privilege information for accessing the sub-tree, etc. After the profile information the sub-trees contain search strings, or differential bits that lead to each of the entries in the sub-tree. Each search string ends in a result string. The result string can be actual data, can be a pointer to another sub-tree, can be a function call, or can be any other useful data or entry.

### TECHNICAL FIELD OF THE INVENTION

The present invention relates to processor engines that manipulate database structures and to database structures for storing, searching and retrieving data.

### BACKGROUND OF THE INVENTION

The term database has been used in an almost infinite number of ways. The most common meaning of the term, however, is a collection of data stored in an organized fashion. Databases have been one of the fundamental applications of computers since they were introduced as a business tool. Databases exist in a variety of formats including hierarchical, relational, and object oriented. The most well known of these are clearly the relational databases, such as those sold by Oracle, IBM and Microsoft. Relational databases were first introduced in 1970 and have evolved since then. The relational model represents data in the form of two-dimensional tables, each table representing some particular piece of the information stored. A relational database is, in the logical view, a collection of two-dimensional tables or arrays.

Though the relational database is the typical database in use today, an object oriented database format, XML, is gaining favor because of its applicability to network, or web, services and information. Objected oriented databases are organized in tree structures instead of the flat arrays used in relational database structures. Databases themselves are only a collection of information organized and stored in a particular format, such as relational or object oriented. In order to retrieve and use the information in the database, a database management system (“DBMS”) is required to manipulate the database.

Traditional databases suffer from some inherent flaws. Although continuing improvements in server hardware and processor power can work to improve database performance, as a general rule databases are still slow. The speeds of the databases are limited by general purpose processors running large and complex programs, and the access times to the disk arrays. Nearly all advances in recent microprocessor performance have tried to decrease the time it takes to access essential code and data. Unfortunately, for database performance, it does not matter how fast a processor can execute internal cycles if, as is the case with database management systems, the primary application is reading or modifying large and varied numbers of locations in memory.

Also, no matter how many or how fast the processors used for databases, the processors are still general purpose and must use a software application as well as an operating system. This architecture requires multiple accesses of software code as well as operating system functions, thereby taking enormous amounts of processor time that are not devoted to memory access, the primary function of the database management system.

Beyond server and processor technology, large databases are limited by the rotating disk arrays on which the actual data is stored. While many attempts have been made at great expense to accelerate database performance by caching data in solid state memory such as dynamic random access memory, (DRAM), unless the entire database is stored in the DRAM the randomness of data access in database management system means misses from the data stored in cache will consume an enormous amount of resources and significantly affect performance. Further, rotating disk arrays require significant time and money be spent to continually optimize the disk arrays to keep their performance from degrading as data becomes fragmented.

All of this results in database management systems being very expensive to acquire and maintain. The primary cost associated with database management systems are initial and recurring licensing costs for the database management programs and applications. The companies licensing the database software have constructed a cost structure that charges yearly license fees for each processor in every application and DBMS server running the software. So while the DBMS is very scalable the cost of maintaining the database also increased proportionally. Also, because of the nature of the current database management systems, once a customer has chosen a database vendor, the customer is for all practical purposes tied to that vendor. Because of the extreme cost in both time, expense and risk to the data, changing database programs is very difficult, this is what allows the database vendors to charge the very large yearly licensing fees that currently standard practice for the industry.

The reason that changing databases is such an expensive problem relates to the proprietary implementations of standardized database languages. While all major database programs being sold today are relational database products based on a standard called Standard Query Language, or SQL, each of the database vendors has implemented the standard slightly differently resulting, for all practical purposes, in incompatible products. Also, because the data is stored in relational tables in order to accommodate new standards and technology such as Extensible Mark-up Language (“XML”) which is not relational, large and slow software programs must be used to translate the XML into a form understandable by the relational products, or a completely separate database management system must be created, deployed and maintained for the new XML database.

One way to overcome the limitations of traditional software databases would be to implement a database management system capable of performing basic database functions completely in hardware. To get the full benefit from a hardware implementation, however, the data itself would need to be stored in random access memory (“RAM”) instead of on rotating disks, and a data structure optimized for hardware processing would need to be developed. Accordingly, what is needed is a graph engine and data structure for a hardware database management system.

### SUMMARY OF THE INVENTION

The present invention provides for a data structure for a database management engine implemented entirely in hardware. The data structure is used to store information in a database in a manner not limited by protocols such as relational data or hierarchical data.

The data structure in the database created and accessed by the graph engine is in the form of graphs made up of individual sub-trees. Each sub-tree begins at a location in memory identified by a root tree address. The sub-tree then contains tree i.d. information and profile information about the nature and contents of the sub-tree. After the profile information the sub-tree branches into the search strings, or differential bits that identify the information in the sub-tree. Each branch in the search strings ends in a result that can be any useful information including a pointer to a new root tree address, a function call, or actual data in the database. The sub-trees may point to the root address of many other sub-trees in the database resulting in the graph nature of the database structure.

Further a method of creating such a data structure is described. The method begins by selecting a root address for a sub-tree in the data structure. Profile information is written giving information on the sub-tree, and signature strings are created representing the branches in the sub-tree for each entry in the sub-tree, wherein the signature strings point to results strings that represent the entries in the sub-trees, the entries representing data in the database, pointers to other sub-trees, or other information required to store and access the data in the database. The method can be repeated to create other sub-trees, each sub-tree capable of pointing to other sub-trees in the data structure.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a database management system using the graph processor of the present invention;

FIG. 2 illustrates an example of a context data block for use with the graph processor of the present invention;

FIG. 3 illustrates an example of a sub-tree data structure in accordance with the present invention;

FIG. 4 illustrates multiple sub-tree data structures forming a database data structure in accordance with the present invention; and

FIG. 5 illustrates a block diagram a graph processor in accordance with the present invention.

### DETAILED DESCRIPTION OF THE DRAWINGS

Traditional databases use well defined data structures that have existed in the computer industry for decades. The most well known data structure is the one used by relational databases where data is stored in tables comprised of multiple columns and rows, the data being stored is identified by specifying the table, row, and column. Tables, in relational databases, can be nested, or reference other tables, eliminating much of the need for multiple copies of data to exist in a single database and allowing more data to be stored in the available storage media, usually rotating disks. The other primary data structure in use is the simple binary tree structure used by extensible markup language (“XML”) databases. Binary tree structures store information in a tree structure where information is accessed by following the appropriate branches in the tree.

Each of these structures has been developed for use with the particular software programs that interact with the database structures. Moving database functionality from a software program running on an operating system running on a general purpose server, to a fully hardware database management system (“DBMS”) results in a new data structure for the database to best implement the hardware DBMS. This new database structure should be protocol independent to allow the hardware DBMS to process both relational and binary protocols without needing to resort to translation programs to convert the binary protocol into a relational protocol or vice versa. Further the database needs to be stored in RAM instead of on disk arrays as with traditional databases. This allows for much quicker access times than with a traditional database.

Instead of storing data in the table format used by the relational databases, the graph engine and data structure of the present invention stores data in a graph structure where each entry in the graph stores information and/or information about subsequent entries. The graph structure of the database provides a means for storing the data efficiently so that much more information can be stored than would be contained in a comparable disk array using a relation model. One such structure for a database, which along with other, broader, graph structures may be used in the present invention, is described in U.S. Pat. No. 6,185,554 to Bennett, which is hereby incorporated by reference. The memory holding the database can contain multiple banks of RAM and that RAM can be co-located with the graph engine, can be distributed on an external bus, or can even be distributed across a network.

Referring now to FIG. 1, a data flow engine implementing a database management system using the graph processor of the present invention is shown. Data flow engine 10 is formed by parser 12, execution tree engine 14, and graph processor 18. Parser 12 acts to break down statements, such as SQL statements or XML statements, into executable instructions and data objects associated with these units. The parser takes each new statement and identifies the operators and their associated data objects. For example, in the SQL statement SELECTDATA FROM TABLE WHERE DATA2=VALUE, the operators SELECT, FROM, WHERE, and =are identified as operators, while DATA, TABLE, DATA2, and VALUE, are identified as data object. The operators are then converted into executable instructions while the data objects are associated with their corresponding operator and stored in memory. When the parser is finished with a particular statement, a series of executable instructions and links to their associated data are sent to execution tree engine 14 for further processing.

Once the executable instructions and data objects are ready to be processed, execution tree engine validates that the executable instructions are proper and valid. Execution tree engine 14 then takes the executable instructions forming a statement and builds an execution tree, the execution tree representing the manner in which the individual executable instructions will be processed in order to process the entire statement represented by the executable instructions. An example of the execution tree for the SQL statement SELECTDATA FROM TABLE WHERE DATA2=VALUE can be represented as:

| SELECT | |
|---|---|
| / | \ |

| | |
|---|---|
| DATA | WHERE |

| | |
|---|---|
| / | \ |

| | |
|---|---|
| FROM | = |

| | | |
|---|---|---|
| / | / | \ |

| | | |
|---|---|---|
| TABLE | DATA2 | VALUE |
| | / | |

```
  FROM
    /
```

TABLE

The execution tree once assembled would be executed from the elements without dependencies toward the elements with the most dependencies, or from the bottom up to the top in the example shown. Branches without dependencies on other branches can be executed in parallel to make handling of the statement more efficient. For example, the left and right branches of the example shown do not have any interdependencies and could be executed in parallel.

Execution tree engine 14 takes the execution trees and identifies those elements in the trees that do not have any interdependencies and schedules those elements of the execution tree for processing. Each element contains within it a pointer pointing to the location in memory where the result of its function should be stored. When each element is finished with its processing and its result has been stored in the appropriate memory location, that element is removed from the tree and the next element is then tagged as having no interdependencies and it is scheduled for processing by execution tree engine 14. Execution tree engine 14 takes the next element for processing and waits for a thread in execution units 16 to open.

Execution units 16 act to process the individual executable instructions, with their associated data objects. Execution units 16 perform numerical, logical, and other complex functions required by the individual instructions that do not require access to the data in the database. For example, execution units 16 perform string processing and floating point function, and are also able to call routines outside of dataflow engine 10. Execution units 16 are also able to send instructions and their associated data to graph processor 18 whenever an instruction requires manipulating the database, such as performing read, write, alter or delete functions to the data in the database.

Executable instructions or function calls that require access to the entries in the database are sent to graph processor 18. Graph processor 18 includes context handling 20 and graph engine 22. Context handling 20 schedules the multiple contexts that can be handled by graph engine 22 at one time. In the current embodiment of the graph engine up to 64 individual contexts, each associated with a different statement or function being processed, can be processed or available for processing by graph engine 22.

Graph processor 18 provides the mechanisms to read from, write to, and alter the database. The database itself is stored in database memory 24 which is preferably random access memory, but could be any type of memory including flash or rotating memory. In order to improve performance as well as memory usage, the information contained in the database is stored in memory differently than traditional databases. Traditional databases, such as those based on the SQL standard, are relational in nature and store the information in the databases in the form of related two-dimensional tables, each table formed by a series of columns and rows. The relational model has existed for decades and is the basis for nearly all large databases. Other models have begun to gain popularity for particular applications, the most notable of which is XML which is used for web services and unstructured data. Data in XML is stored in a hierarchical format which can also be referred to as a tree structure.

The database of the present invention stores information in a data structure unlike any other database. The present invention uses a graph structure to store information. In the well known hierarchical tree structure there exists a root and then various nodes extending along branches from the root. In order to find any particular node in the tree one must begin at the root and traverse the correct branches to ultimately arrive at the desired node. Graphs, on the other hand, are a series of nodes, or vertices, connected by arcs, or edges. Unlike a tree, a graph need not have a specific root and unique branches. Also unlike a tree, vertices in a graph can have arcs that merge into other trees or arcs that loop back into the same tree.

In the case of the database of the present invention the vertices are the information represented in the database as well as certain properties about that information and the arcs that connect that vertex to other vertices. Graph processor 18 is used to construct, alter and traverse the graphs that store the information contained in the database. Graph processor 18 takes the executable instructions that require information from, or changes to, the database and provides the mechanism for creating new vertices and arcs, altering or deleting existing vertices or arcs, and reading the information from the vertices requested by the statement being processed.

The graphs containing the database are stored in database memory 24. Database memory 24 can be either local to data flow engine 10 or can be remote from data flow engine 10 without affecting its operation.

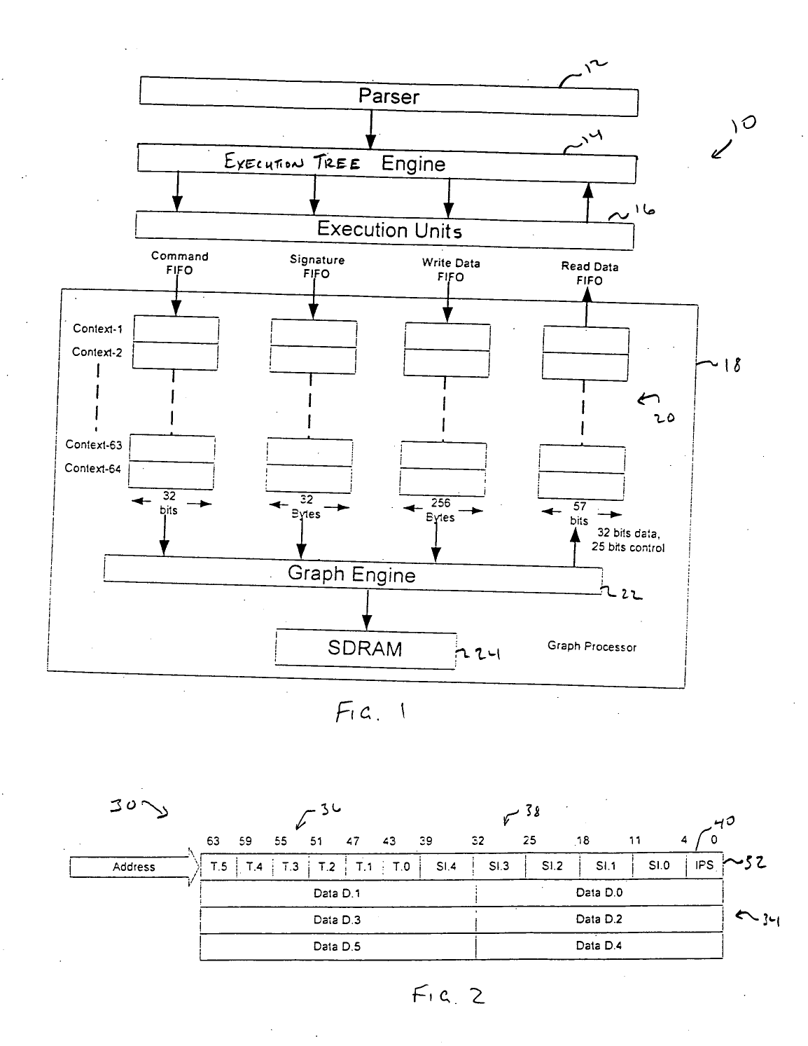

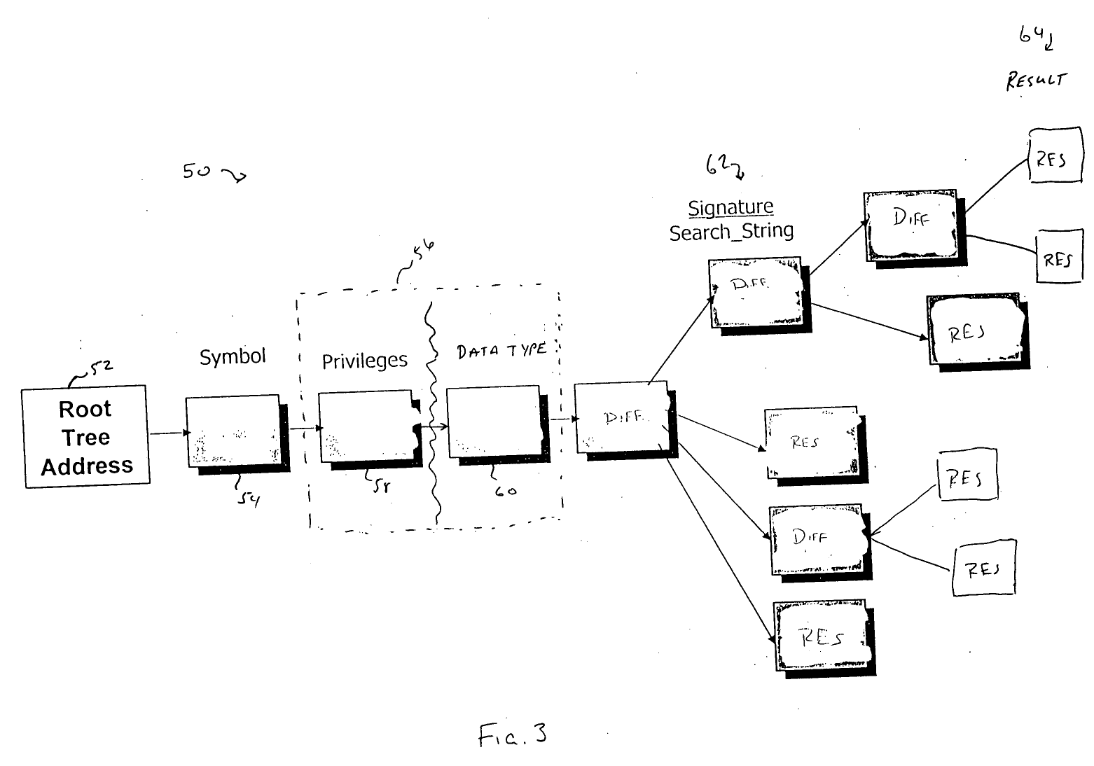

Referring now to FIG. 2, an example of a context data block is shown. Block 30 includes header 32 and data payload 34. Header 32 includes information on the type of data in the cell, the action to be taken by the cell, and the structure of the instruction used by the cell. The type of data in the cell is represented by the 4 bit data instances shown by T0 through T5. The type of data in the cell could be many things including alpha numeric strings, address pointers, floating point numbers, etc. The action to be taken by the cell is in the form of a sub-instruction shown by 7 bit instances SI0 through SI4. The sub-instruction data tells the graph processor what to do with the data block. The instruction structure is shown by 5 bit instance IPS which lets the sub-instructions be formatted in different ways with the bits of the IPS instance informing the graph engine which format the sub-instruction is in.

The remaining six 32 bit words contain the data for the graph engine to work with. As stated the data can be any number of types of data as designated by the data type in the header. While context data block 30 has been shown with reference to particular bit structures, one skilled in the art will recognize that different structures of the data block could be implemented without affecting the nature of the current invention.

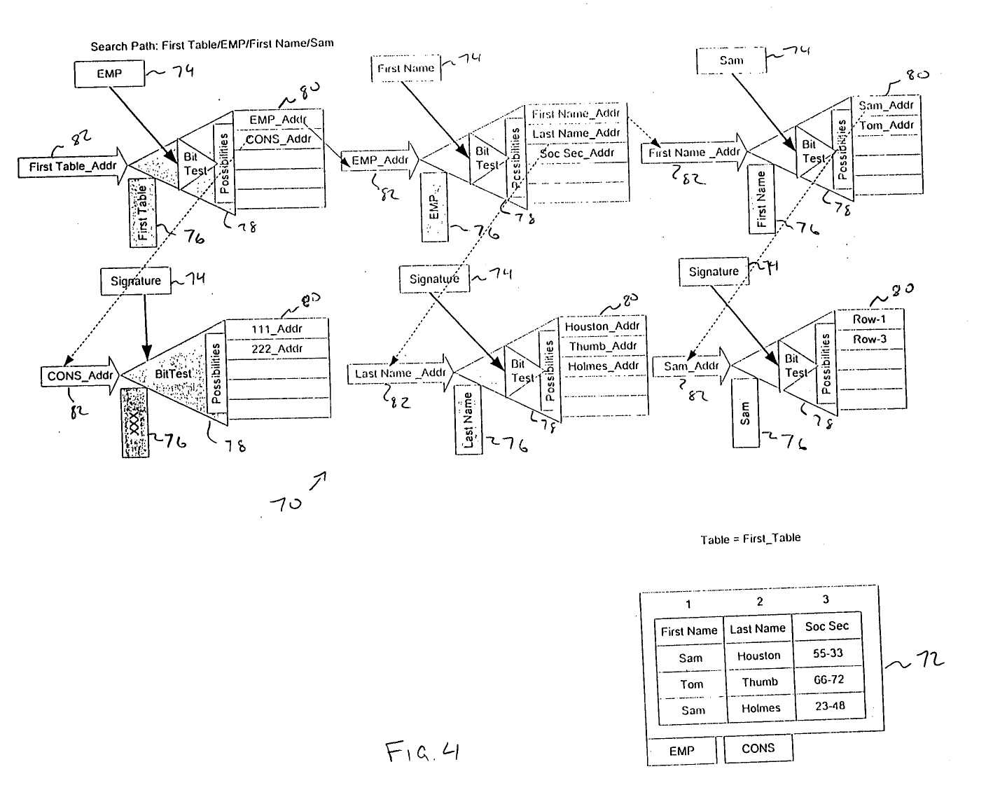

Referring now to FIG. 3, an example of a sub-tree data structure is shown. The data in the database created and manipulated by graph processor 18 from FIG. 1 is stored in a data structure different than the data structures used by conventional relational or XML databases. The data in present invention is stored in multiple interconnected sub-tree structures such as sub-tree structure 50. Sub-tree structure 50 includes four components: tree i.d., or symbol 54, profile data 56, signature strings, or differential bits 62, and results strings 64. Each sub-tree has a root tree address that provides entry into the sub-tree. At the beginning of each sub-tree, after tree i.d. 54, a set of data is stored which provide information about the tree itself. This information allows graph processor 18 from FIG. 1 to be very efficient in searching the tree, using the available memory, and providing security to the information stored in the database. This information, the profile data 56, can include any information that would increase the utility or efficiency of the graph processor, including such information as the type of data being stored in the tree, i.e. character strings, urls, functions, floating point number, integer, etc. Other information that would normally be included in profile data 56 is the cardinality, or number of entries, of the tree, and locking information, used when access to the tree needs to be limited.

After the profile data the tree includes the search strings 62, or differential bits, shown as blocks DIFF. An input string, which is the object that the graph processor is matching to is compared with the search string of the sub-tree. Using the search string with the input string an address is formed that leads to the location in memory of the next search string. Each sub-tree is traversed in this manner by taking an input string together with a search string from the tree and using these to move to a location in memory. At the end of each branch of search strings 62 in sub-tree 50 are results 64. Results for a sub-tree can either be the actual data from the database to be returned, or it can be other functional information for the graph processor. Such functional information includes things like address pointers to other sub-trees in the database, either because the data is being accessed through multiple layers, such as nested tables in relational databases, or because the differential bit portion 62 of sub-tree 50 became too large requiring the use of multiple sub-trees to accommodate the search strings. In the latter case, the result would be the root tree address of the sub-tree continuing the search string match. Other functional information would include calls to functions outside the graph processor, such as the floating point processor, or calls to external routines outside the data flow engine.

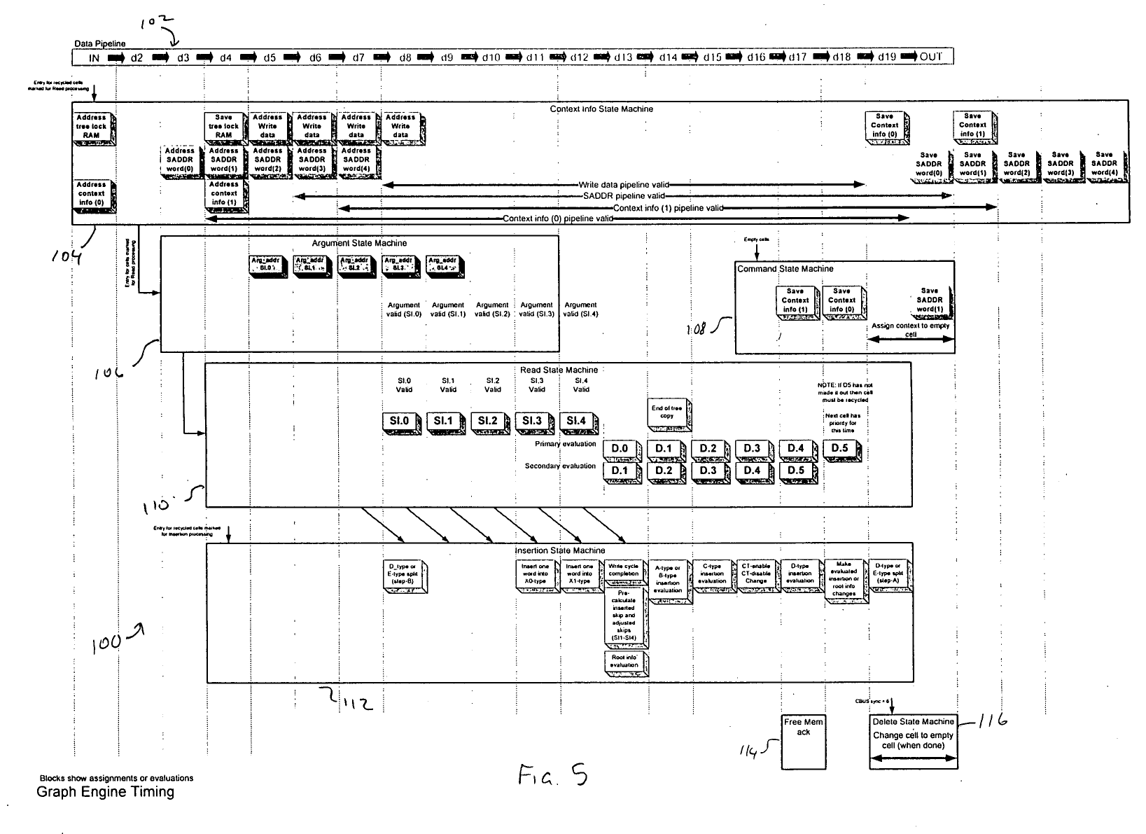

Referring now to FIG. 4, an example of a graph data structure formed by multiple sub-trees is shown. Graph 70 is a representation of relational data stored in a data structure according to the present invention. Part of the data represented in graph 70 is shown in a traditional relational table format in First_Table 72. Each of the sub-trees includes root tree address 82, tree i.d. and privilege information 76, bit test 78 and results 80. As described with reference to FIG. 3, an input string 74 can be inputted to a sub-tree and a differential bit test determines matches for the input string.

To illustrate the operation of the graph data structure represented by graph 70, a search operation, such as an SQL select statement, requesting information from First_Table 72 on employees with the first name Sam will be followed as it traverses the sub-trees. Root tree address First Table_Address identifies the location memory of sub-tree First Table. Input string EMP is compared to the differential bit test portion of table First Table, and returns the result EMP_Addr. Result EMP_Addr is a pointer to root address EMP_Addr, which identifies the location in memory of sub-tree EMP. Using the sub-tree EMP, input string First Name, is compared to the differential bit test portion of table EMP, returning the result First Name_Addr. Result First Name_Addr again is a pointer to root address First Name_Addr for sub-tree First Name. Similarly, input string SAM is then inputted to sub-tree First Name, and returns the pointer Sam_Addr, which is the root address of sub-tree Sam. The graph engine can then read the results of sub-tree Sam, shown as results Row-1, and Row-3 which hold the data in table First_Table related to employees named Sam.

From the example above it can be seen how the graph engine is operable to ‘walk’ the sub-trees to access data in the database. Writing and altering the database is exactly the same as the read function, with the data being written to the memory instead of being read. The writing of information to the database will be discussed further with reference to FIG. 5.

Referring now to FIG. 5, a block diagram of the graph engine is shown. Graph engine 100 is a pipelined engine with each stage 102 of the pipeline performing corresponding to a particular operation or operations. Cells, in the form of context data block 30 from FIG. 2, are sent to graph engine 100 from execution units 16 from FIG. 1 through context handling 20, or are returned from memory 24 from FIG. 1 for further processing, as will be described. Each cell enters context engine 104 of graph engine 100 at state IN of pipeline stages 102. Context engine 104 maintains the state for each of the cells being processed by graph engine 100 by setting up the appropriate information from the cells in the appropriate registers within the graph engine. It may take several cells for the graph engine to receive all the necessary information to begin accessing the database. For example, one cell may contain the root tree address to be used as the starting point in a read from the database, and a second cell may be required to pass the argument, or search object to be processed. Further, it may require more than one access to the tree to process an argument.

Cells can pass back and forth between the graph engine and memory multiple times to execute a single instruction in a context block. Once context block may pass between the graph engine and memory multiple times to ‘walk’ the graph and sub-trees in memory, as described with reference to FIG. 4. For read functions, argument engine 106 and command engine 108 are loaded with the search object and read command. The thread information is saved and a cell is issued to read from the database memory at the root address for a new read or from the last address pointer for a continuing read. The contents of the memory location are returned in the data portion of the cell and sent to read engine 110 where the differential bits of the argument, or search object are compared to the contents of the data location. This differential bit comparison continues, possibly with additional accesses to the database memory to retrieve additional data for comparison, until a result from the comparison is reached. This result, as is described with reference to FIGS. 3 and 4 can be the actual data from the database, or can be a pointer to another sub-tree. If the result is actual data from the database the graph engine can either do a bit for bit comparison to check for exact matches between the data and the search object, or can return some amount of data from the database that corresponds to the search object as is required by the particular instruction. For example, the graph engine could check to see if there is an exact entry for Sam Houston in the employee database, or it could return all entries with a first name beginning with the letters sam.

The write engine 112 operates similarly to the read function, but requires two steps to perform the write to the database memory. The first step uses the read engine 110 to perform a read from the database as described above. In the case of a write, however, the read functions to find the first differential bit between the search object and the contents of the database, in other words the first place where there is a difference between the search object and the data existing in the database. Once this point is found write engine 112 inserts a new node at the differential point and writes the appropriate data into the memory to form a new branch or even new sub-tree as required to add the information. As with the read, it will take many passes between the graph engine and database memory to write information into the database.

When an instruction is completed, graph engine 100 uses free memory acknowledgement 114 to indicate that the thread is complete and can release the cells being used back into the free cell list for use by another or new thread or instruction. Delete engine 116 deletes any residual information from the cells that have been released.

Although particular references have been made to specific protocols, implementations and materials, those skilled in the art should understand that the database management system can function independent of protocol, and in a variety of different implementations without departing from the scope of the invention in its broadest form.

1. A data structure for storing data in a database comprising:
at least one sub-tree, each of the at least one sub-tree being associated with a distinct root tree address and including profile data storing information about the sub-tree, signature strings for matching a search object against entries in the sub-tree, and results strings representing the entries in the sub-tree.

2. The data structure of claim 1 wherein the results strings are the data entries in the database.

3. The data structure of claim 1 wherein the results strings are the root addresses of other sub-trees.

4. The data structure of claim 1 wherein the sub-tree further includes a tree id.

5. The data structure of claim 1 wherein the profile data includes information about the data type stored in the sub-tree.

6. The data structure of claim 1 wherein the profile data includes information about privileges for accessing the sub-tree.

7. The data structure of claim 1 wherein one sub-tree points to the root address of other sub-trees.

8. The data structure of claim 7 wherein a sub-tree represents a column in a relational table.

9. The data structure of claim 1 wherein the sub-strings represent the differential bits for each entry in the sub-tree.

10. A method for creating a data structure in hardware database, the method comprising:
selecting a root address for a sub-tree;
writing profile information for the sub-tree accessible by the root address; and
creating signature strings in the sub-tree, each signature string leading to a result string, wherein the result string represents an entry in the sub-tree.

11. The method of claim 10 further comprising after creating, repeating the method to create additional sub-trees, wherein the results strings contain the root addresses of other sub-trees, thereby linking the sub-trees into a graph structure.

12. The method of claim 10 wherein the entry in the sub-tree is data stored in the database.

13. The method of claim 12 wherein the profile information includes privilege information.

14. A data structure for storing data in a database in memory comprising:
a plurality of sub-trees containing entries in the database, each sub-tree including a root address, profile data, signature strings and results strings, wherein the root address is the address in memory where the sub-tree begins, the profile data contains information about the sub-tree, the signature strings are branches in the sub-tree leading to each entry in the sub-tree, and results strings representing each entry in the sub-tree;
such that each sub-tree can refer to other sub-trees by using the appropriate root address as the results string.

15. The data structure of claim 14 wherein the profile data includes privilege information for accessing the sub-tree.

16. The data structure of claim 14 wherein a sub-tree represents a column in a relational table.

17. The data structure of claim 14 wherein the sub-strings represent the differential bits for each entry in the sub-tree.
